(19) United States
(12) Patent Application Publication
(10) Pub. No.: US 2024/0061874 A1
(43) Pub. Date: Feb. 22, 2024

(54) A TEXT SUMMARIZATION PERFORMANCE EVALUATION METHOD SENSITIVE TO TEXT CATEGORIZATION AND A SUMMARIZATION SYSTEM USING THE SAID METHOD

(71) Applicant: SESTEK SES VE ILETISIM BILGISAYAR TEK.SAN.TIC.A.S., ISTANBUL (TR)

(72) Inventors: Mustafa Levent ARSLAN, ISTANBUL (TR); Murat SARACLAR, ISTANBUL (TR); Mustafa ERDEN, ISTANBUL (TR); Abdullah Samil GUSER, ISTANBUL (TR)

(73) Assignee: SESTEK SES VE ILETISIM BILGISAYAR TEK.SAN.TIC.A.S., ISTANBUL (TR)

(21) Appl. No.: 18/269,579

(22) PCT Filed: Dec. 2, 2021
(86) PCT No.: PCT/TR2021/051333

§ 371 Date: Jun. 26, 2023

(30) Foreign Application Priority Data
Dec. 28, 2020 (TR) 2020/22040

(51) Int. Cl. G06F 16/34; G06F 40/30

(52) U.S. Cl. CPC G06F 16/345; G06F 40/30

(57) ABSTRACT

A summarization performance evaluation method, and a summarization system sensitive to text categorization using the evaluation method is provided. The summarization system includes a database for storing the text to be summarized, a learning module which performs learning with machine learning in order to identify the categories and extract the summary of the text uploaded to the database, a categorization unit which identifies the categories of the text as a result of machine learning of the learning module, and is provided in the learning module, a sentence unit which summarizes the text as a result of machine learning of the learning module, and is provided in the learning module, a text summarization performance evaluation module for comparing the topic scores.

### CROSS REFERENCE TO RELATED APPLICATIONS

This application is the national phase entry of International Application No. PCT/TR2021/051333, filed on Dec. 2, 2021, which is based upon and claims priority to Turkish Patent Application No. 2020/22040, filed on Dec. 28, 2020, the entire contents of which are incorporated herein by reference.

### TECHNICAL FIELD

The present invention relates to a text summarization performance evaluation method which is used in summarizing long texts and evaluates the compatibility of the original text with the summarized text, and a summarization system sensitive to text categorization using the said evaluation method. The text summarization system and method disclosed in the present invention is a method applicable for extracting summaries of all types of texts including long texts transcribed from speech to text or scientific articles.

### BACKGROUND

The process of rewriting a text in a shorter manner without losing the main idea is known as text summarization. There are two types of summarization methods in the literature. Extractive or selective summarization, which is a summarization approach, creates a summary by selecting important elements in the text and bringing them together without changing them or with minimal changes. In the method of abstractive summarization, which is the other approach, a summary, which preserves the main idea and meaning in the text, is created by generating new sentences without preserving the text in the document literally.

It is quite important to automatically evaluate the quality of the summaries extracted by different methods. Carrying out this evaluation with the human factor causes the evaluation result to be subjective and this method is a very time-consuming and expensive evaluation. As an alternative to human evaluation, several automatic evaluation methods have been proposed in the literature. The ROUGE metric used in the state-of-the-art works by comparing an automatically created summary with a reference summary usually created by humans. There are different types of the ROUGE metric, such as the ROUGE-1, ROUGE-2, and ROUGE-L.

Text Analysis Conference (TAC) and Document Understanding Conference (DUC) have used the ROUGE metric in evaluations as it produces results correlated with manual evaluations. However, because it looks for common sequences between summaries, ROUGE metric does not consider words with similar meanings. ROUGE score in this case becomes inaccurate.

Another problem of ROUGE metric is that every word contributes equally to the score when the evaluation score is being calculated. However, the importance of each word is different. In addition, when ROUGE is applied especially to a morphologically rich language, inflections change the overall structure of the output. Therefore, it is not always possible to make an accurate evaluation with the ROUGE metric.

For the summary evaluation methods used in the state of the art, manually extracted summaries are needed. Manual summarization is difficult and can be processed with limited amount of data.

### SUMMARY

The objective of the present invention is to provide a text summarization performance evaluation method, which, unlike the ROUGE method, performs summary evaluation without requiring the reference summary, and a summarization system sensitive to text categorization using the proposed evaluation method.

The objective of the present invention is to provide a text summarization performance evaluation method which achieves a more accurate evaluation in all types of texts including scientific articles or long texts transcribed by speech to text engines, and a summarization system employing the proposed evaluation method which is based on text categorization.

### BRIEF DESCRIPTION OF THE DRAWINGS

A text summarization performance evaluation method, and a summarization system sensitive to text categorization using the said evaluation method developed to fulfil the objectives of the present invention is illustrated in the accompanying figures, in which:

FIG. 1 is a schematic view of the summarization system of the present invention.

FIG. 2 is a schematic view of an embodiment of the summarization method of the present invention.

FIG. 3 is a schematic view of a first preferred embodiment of the summarization method of the present invention.

FIG. 4 is a schematic view of a second preferred embodiment of the summarization method of the present invention.

### DETAILED DESCRIPTION OF THE INVENTION

The components shown in the FIGS. are each given reference numbers as follows:
1. Summarization system
2. Database
3. Learning module
4. Categorization unit
5. Sentence unit
6. Text summarization performance evaluation module
100 Summarization method
100A Summarization method
100B Summarization method

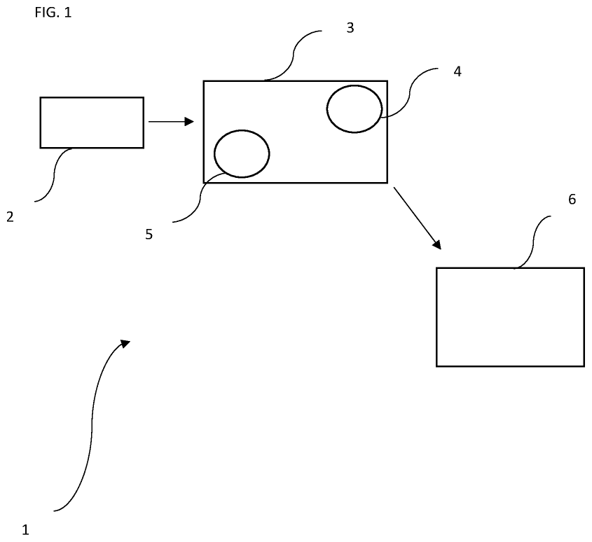

Referring to FIG. 1, a summarization system (1), which automatically calculates the similarity between a text and a summary of the text without requiring a reference summary, essentially comprises
at least one database (2) for storing the text to be summarized,
at least one learning module (3) which performs learning with machine learning in order to identify the categories and extract the summary of the text uploaded to the database,
at least one categorization unit (4) which is configured to identify the categories of the text as a result of machine learning of the learning module, and is provided in the learning module,
at least one sentence unit (5) which is configured to summarize the text as a result of machine learning of the learning module, and is provided in the learning module,
at least one text summarization performance evaluation module (6) for comparing the topic scores by means of identifying the categories of the text and the summarized text via the categorization unit and for identifying an evaluation score by means of calculating the similarity in order to evaluate the performance of the summary created by any summarization algorithm.

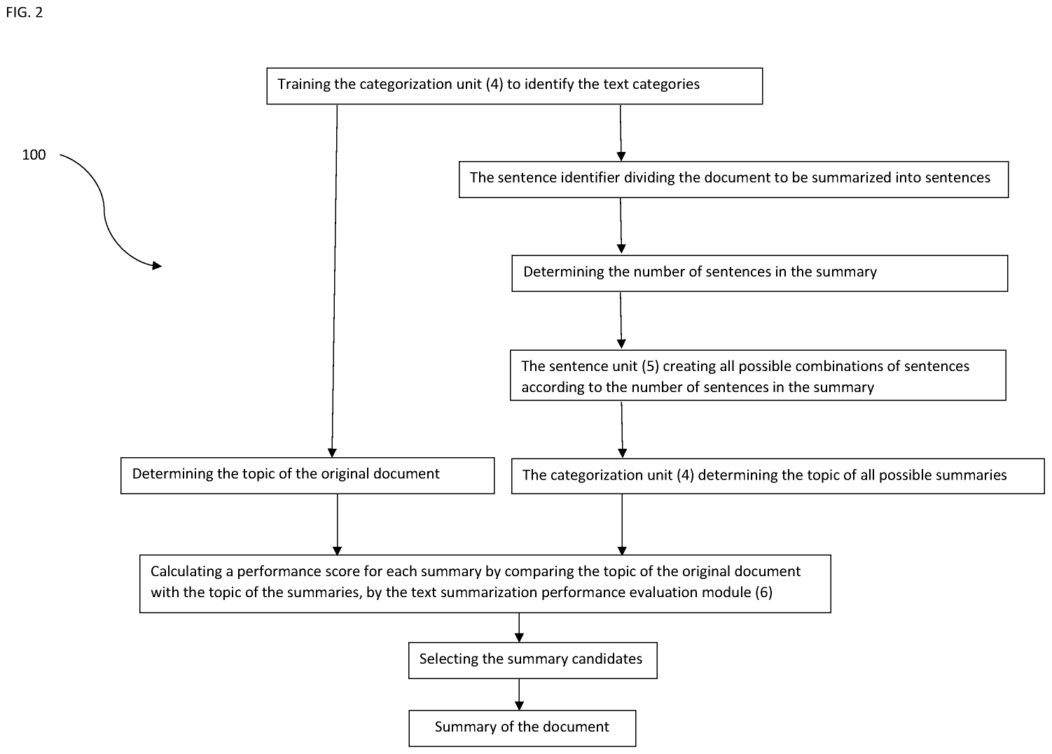

Referring to FIGS. 1 and 2, a summarization method (100), which automatically calculates the similarity between a text and a summary of the text without requiring a reference summary, essentially comprises the process steps of
training the categorization unit (4) to identify the text categories,
the sentence identifier dividing the document to be summarized into sentences,
determining the number of sentences in the summary,
the categorization unit (4) determining the topic of the original document,
the sentence unit (5) creating all possible combinations of sentences according to the number of sentences in the summary,
the categorization unit (4) determining the topic of all possible summaries,
the text summarization performance evaluation module (6) determining the summary closest to the original document's score among all possible summaries by examining the topic scores.

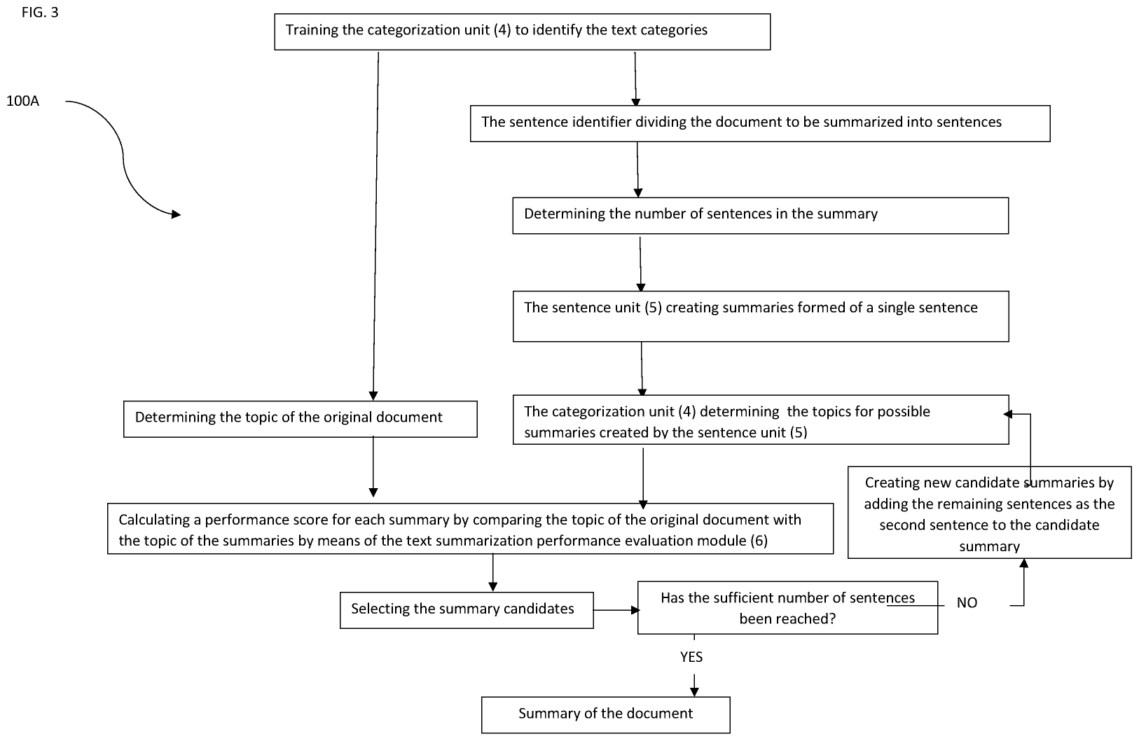

Referring to FIGS. 1 and 3, a summarization method (100A), which automatically calculates the similarity between a text and a summary of the text without requiring a reference summary, essentially comprises the process steps of
training the categorization unit (4) to identify the text categories,
the sentence identifier dividing the document to be summarized into sentences,
determining the number of sentences in the summary,
the sentence unit (5) creating summaries formed of a single sentence,
the categorization unit (4) determining the topic of the original document,
the categorization unit (4) determining the topics of the summaries,
calculating a performance score for each summary by comparing the topic of the original document with the topic of the summaries by means of the text summarization performance evaluation module (6),
selecting the most suitable summary candidates according to the performance score of the text summarization performance evaluation module (6),
adding the remaining sentences to the summary until the predetermined number of sentences in the summary is reached.

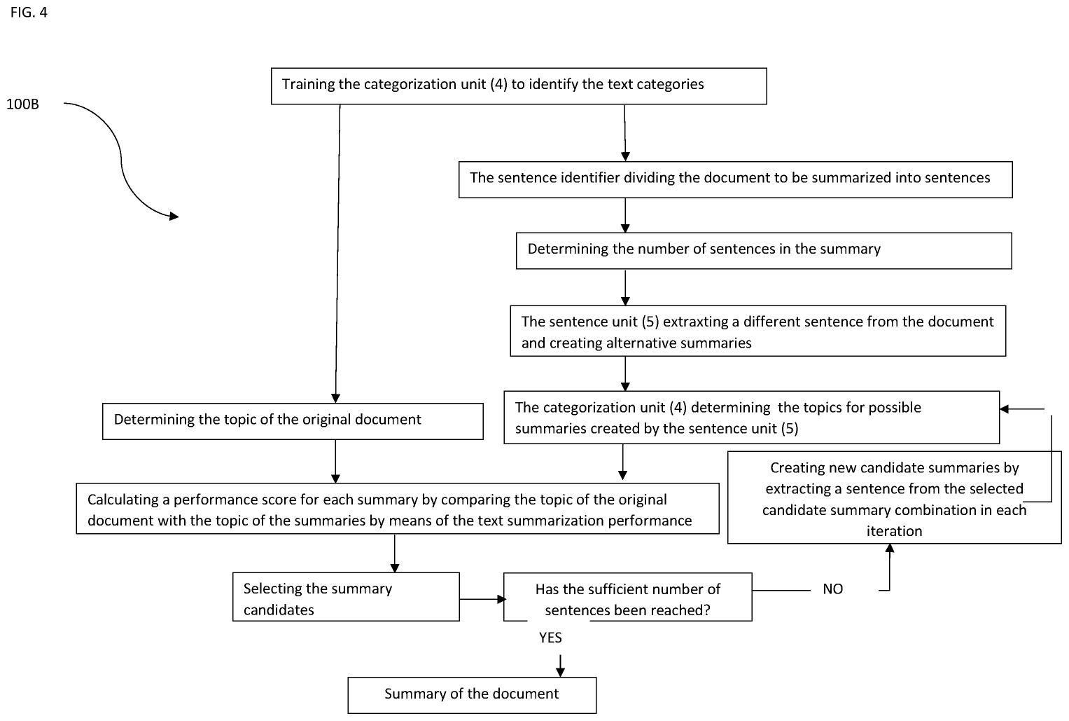

Referring to FIGS. 1 and 4, a summarization method (100B), which automatically calculates the similarity between a text and a summary of the text without requiring a reference summary, essentially comprises the process steps of
training the categorization unit (4) to identify the text categories,
the sentence identifier dividing the document to be summarized into sentences,
determining the number of sentences in the summary,
the sentence unit (5) creating candidate summaries by extracting one sentence from the whole document for each summary,
the categorization unit (4) determining the topic of the original document,
the categorization unit (4) determining the topics of the summaries,
calculating a performance score for each summary by comparing the topic of the original document with the topic of the summaries by means of the text summarization performance evaluation module (6),
selecting the most suitable summary candidates according to the performance score of the text summarization performance evaluation module (6),
removing the remaining sentences from the summary until the predetermined number of sentences in the summary is reached.

Referring to FIG. 1, the summarization system (1) of the present invention provides the automatic evaluation of the compatibility between a text and a summary of the text and the calculation of an evaluation score as a result of the evaluation. A categorization unit (4) trained in the field of the summary text is needed in order to perform the evaluation with the summarization system (1) of the present invention.

Again referring to FIG. 1, a summarization system (1) according to the present invention comprises at least one database (2) for storing the text to be summarized, at least one learning module (3) which performs learning with machine learning and clustering model in order to identify the categories and extract the summary of the text uploaded to the database, at least one categorization unit (4) which is configured to identify the categories of the text as a result of machine learning of the learning module, and is provided in the learning module, at least one sentence unit (5) which is configured to summarize the text as a result of machine learning of the learning module, and is provided in the learning module, at least one text summarization performance evaluation module (6) for comparing the topic scores by means of identifying the categories of the text and the summarized text via the categorization unit (4) and for identifying an evaluation score by means of calculating the similarity ratio.

Still referring to FIG. 1, reference summaries are required when performing a summary evaluation with other summary evaluation applications such as the ROUGE metric used in the current art. There is no need for a reference summary when performing an evaluation with the summarization system (1), because the system (1) uses the text summarization performance evaluation module (6), which aims to keep the output of the text categorization unit (4) constant. Therefore, there is no need for a dataset which will include the reference summary in order to perform evaluation with the text summarization performance evaluation module (6) of the present invention. The database (2) is taught to the learning module (3). Categorization and sentence units (4, 5) in the learning module (3) are also trained in the same manner. The categorization unit (4) is trained under supervision with labelled data, if available. If there is no labelled data, the sets obtained from unsupervised clustering are used as different categories.

After determining the categories of both the original text and the summary, a match score is calculated by the text summarization performance evaluation module (6) by comparing the categories of the text and the summary in order to compute the quality of the summary. Since this match score is calculated based not on words but on categories, the results are more realistic than those of the other evaluation methods.

Sentence identifier configured to identify the sentences uses punctuation marks and capital letters, if any, in the incoming text in order to identify the sentences in the original document. If there are no punctuation marks and capital letters, the sentence identifier determines the sentence boundaries statistically. In addition, an alternative method is to train artificial intelligence module under supervision with labelled data in terms of sentence boundaries method.

In one embodiment of the invention, the BERT model is used in the categorization unit (4). The BERT categorizer learns word embeddings along with their context; the produced confidence score also includes the relationship between similar words. BERT is a pre-trained unsupervised natural language processing model. BERT can perform much better for the 11 most common NLP tasks after fine tuning, which is crucial for Natural Language Processing and Understanding. BERT is deep bidirectional; that is, it learns from pre-trained assets and context on Wikipedia by looking at the words before and after the context in order to provide a richer understanding of language.

Referring to FIGS. 1 and 4, in the summarization method (100B) of the present invention, firstly the categorization unit (4) is trained by the texts with topic labels. If there is no topic labelled data, different clusters can be identified automatically with unsupervised clustering. Then, the document to be summarized is divided into sentences by means of the sentence identifier. The sentence unit (5) decides how many sentences the summary will be comprised of. The sentence unit (5) creates candidate summaries by extracting one sentence from the whole document for each summary. Then the categorization unit (4) determines the topic of the document to be summarized. The categorization unit (4) determines the topic of the extracted candidate summaries. A performance score for each summary is calculated by the text summarization performance evaluation module (6) by comparing the topic of the original document with the topics of the summaries. The most suitable summary candidates are selected according to the performance score of the text summarization performance evaluation module (6). And referring to FIG. 4, the remaining sentences are removed from the summary until the predetermined number of sentences in the summary is reached.

Referring to FIG. 3, in a preferred embodiment of the summarization method (100A) of the present invention, after the most suitable summary candidates are selected according to the performance score, the remaining sentences are added to the summary until the predetermined number of sentences in the summary is reached.

Referring again to FIG. 3, in a preferred embodiment of the summarization method (100A), the categorization unit (4) is trained from texts with similar topic labels. If there is no topic labelled data, different clusters can be identified automatically with unsupervised clustering. Then, the document to be summarized is divided into sentences by means of the sentence identifier. The sentence unit (5) decides how many sentences the summary will be comprised of. Then the categorization unit (4) determines the topic of the document to be summarized and the summaries comprised of a single sentence are evaluated. For these summaries, the scores given by the categorization unit (4) for the topic of the original document are obtained, and added to the summary to be created with the highest scoring summary. For the best summary, the remaining sentences are added to the summary as a second sentence. Then again, for these summaries, the scores given by the categorization unit (4) for the topic of the original document are obtained. At this stage, it is continued with the summaries yielding the highest scores. Each time, one of the remaining sentences are added to the best summary and it is continued until the number of sentences desired in the final summary is reached. Therefore, a method which requires (nk) operations (n: the number of sentences in the original document, k: the number of sentences desired to be in the summary) is obtained instead of the C(n,k) combination.

What is claimed is:

1. A summarization system, which automatically calculates the similarity between a text and a summary of the text without requiring a reference summary, comprising:
at least one database for storing the text to be summarized,
at least one learning module which performs learning with machine learning in order to identify categories and extract the summary of the text uploaded to the database, and
at least one categorization unit which is configured to identify the categories of the text as a result of machine learning of the learning module, and is provided in the learning module, wherein
at least one sentence unit is configured to summarize the text as a result of machine learning of the learning module and is provided in the learning module, and
at least one text summarization performance evaluation module for comparing the topic scores by means of identifying the categories of the text and the summarized text via the categorization unit and for identifying an evaluation score by means of calculating the similarity in order to evaluate the performance of the summary created by any summarization algorithm.

2. The summarization method according to claim 5, and which automatically calculates the similarity between a text and a summary of the text without requiring a reference summary, further comprising the process steps of:
training the categorization unit to identify the text categories,
a sentence identifier dividing the document to be summarized into sentences,
determining the number of sentences in the summary,
a sentence unit creating candidate summaries by extracting one sentence from the whole document for each summary,
after calculating a performance score for each summary, selecting the most suitable summary candidates according to the performance score of the text summarization performance evaluation module,
removing the remaining sentences from the summary until the predetermined number of sentences in the summary is reached.

3. The summarization method according to claim 5, and which automatically calculates the similarity between a text and a summary of the text without requiring a reference summary, further comprising the process steps of:
training the categorization unit to identify the text categories,
a sentence identifier dividing the document to be summarized into sentences,
determining the number of sentences in the summary,
a sentence unit creating summaries formed of a single sentence,
after calculating a performance score for each summary, selecting the most suitable summary candidates according to the performance score of the text summarization performance evaluation module,
adding the remaining sentences to the summary until the predetermined number of sentences in the summary is reached.

4. A summarization method, which automatically calculates the similarity between a text and a summary of the text without requiring a reference summary, comprising the process steps of:
training a categorization unit to identify the text categories,
a sentence identifier dividing the document to be summarized into sentences,
a sentence unit creating all possible combinations of sentences according to the number of sentences in the summary,
the sentence unit creating summaries formed of a single sentence,
the categorization unit determining the topic of the text,
the categorization unit determining the topics of the summaries,
calculating a performance score for each summary by comparing the topic of the original document with the topic of the summaries by means of a text summarization performance evaluation module,
selecting the most suitable summary candidates according to the performance score of a text summarization performance evaluation module.

5. A text summarization evaluation method, which calculates the similarity score of a text and the summary of the text, comprising the process steps of:
a categorization unit determining the topic of the text,
a categorization unit determining the topics of the summaries,
calculating a performance score for each summary by comparing the topic of the original document with the topic of the summaries by means of a text summarization performance evaluation module.

6. A computer program product comprising instructions to execute the steps of the method according to claim 2.

7. A non-transitory computer readable storage medium storing the computer program product according to claim 6.

8. A computer program product comprising instructions to execute the steps of the method according to claim 3.

9. A computer program product comprising instructions to execute the steps of the method according to claim 4.

10. A computer program product comprising instructions to execute the steps of the method according to claim 5.

11. A non-transitory computer readable storage medium storing the computer program product according to claim 8.

12. A non-transitory computer readable storage medium storing the computer program product according to claim 9.

13. A non-transitory computer readable storage medium storing the computer program product according to claim 10.
